(19) United States
(12) Patent Application Publication
(10) Pub. No.: US 2010/0234111 A1
(43) Pub. Date: Sep. 16, 2010

(54) COMMUNICATION METHOD AND SYSTEM OF NETWORK GAME, AND METHOD FOR IMPLEMENTING NETWORK GAME

(75) Inventors: Gang LI, Shenzhen city (CN); Tiebo Wang, Shenzhen city (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Ltd., Shenzhen (CN)

(21) Appl. No.: 12/787,683

(22) Filed: May 26, 2010

Related U.S. Application Data
(63) Continuation of application No. PCT/CN2008/073340, filed on Dec. 4, 2008.

(30) Foreign Application Priority Data
Dec. 27, 2007 (CN) 200710301639.3

(51) Int. Cl. G06F 15/16; A63F 9/24

(52) U.S. Cl. 463/42; 709/203; 709/204; 709/245

(57) ABSTRACT

The embodiments of the present invention provide a communication method of a network game, which includes that: a node server transforms IDs of players in a same scenario into network address indexes of clients according to network address information of the clients and adjacent node servers, the players corresponds to the clients one by one; and a client performs P2P communication with other clients except the client according to the network address indexes. The embodiments of the present invention also provide a communication system of a network game and a method for implementing a network game. By using the embodiments of the present invention, communication efficiency and user experience are improved.

### FIELD OF THE INVENTION

The present invention relates to computer technologies, and more particularly to a communication method and system of a network game, and a method for implementing a network game.

### BACKGROUND OF THE INVENTION

A network game generally refers to a game performed through Internet or a local area network. For example, a network killing game is a plot-type psychology reasoning game. In the network killing game, it is taken as a prototype that a police solves a case, a virtual serial murder is created and detected through talks of many network players; if the virtual serial murder can be detected, the police wins; otherwise, a killer wins.

Currently, communication between players, i.e. message interaction between players in the network game, is implemented mainly through a text transmission mode and an audio-video transmission mode. When the network game is performed through the text transmission mode, the players perform communication only through texts, hence the network game lacks true feels and the efficiency of the network game is not high due to the limitation of typing rate of the players. However, when the network game is performed through the audio-video transmission mode, i.e. when communication and interaction between multiple players in the network game are implemented through a network audio and video transmission technology, the limitation of the text transmission mode is overcome, but network bandwidth occupied by the network game is too large. Especially in the same scenario, e.g. in a network game that many players play in the same virtual room, when it is needed to communicate between clients corresponding to the players, home node servers of the clients need to forward messages. For example, when a client 1 communicates with a client 2, firstly the client 1 sends a message to a home node server of the client 1, i.e. a home node server A; then the home node server A sends the message to a home node server of the client 2, i.e. a home node server B; finally, the home node server B sends the message to the client 2. It can be seen that, the forwarding of the message increases flux from the clients to the home node servers, hence overfull network bandwidth and resources of the node servers are occupied, and communication efficiency is not high.

Therefore, in the conventional communication method of the network game, the communication efficiency is not high. Since the communication efficiency is one of important factors for judging user experiences, the conventional communication method of the network game has a problem of poor user experiences.

### SUMMARY OF THE INVENTION

Embodiments of the present invention provide a communication method of a network game to improve communication efficiency and user experiences.

The embodiments of the present invention provide a communication system of a network game to improve communication efficiency and user experiences.

The embodiments of the present invention also provide a method for implementing a network killing game, by which the network killing game can be implemented with relatively high communication efficiency.

The embodiments of the present invention are implemented as follows.

A communication method of a network game includes:

transforming, by a node server, identities (IDs) of players in a same scenario into network address indexes of clients according to network address information of the clients and adjacent node servers, the players corresponding to the clients one by one; and

performing, by a client, point-to-point (P2P) communication with other clients except the client according to the network address indexes.

A communication system of a network game includes:

a node server, adapted to transform identities (IDs) of players in a same scenario into network address indexes of clients according to network address information of the clients and adjacent node servers, and the players corresponding to the clients one by one; and

a client, adapted to perform point-to-point (P2P) communication with other clients except the client according to the network address indexes.

A method for implementing a network killing game includes:

sending, by a node server, a killing notification message to a client corresponding to a player acting as a killer role, and receiving an identity (ID) of a killed player sent by the client corresponding to the player acting as the killer role;

sending, by the node server, the identity of the killed player to clients corresponding to all players, the players corresponding to the clients one by one;

talking, by the players, by using respective clients;

the method further includes:

transforming, by the node server, IDs of the all players into network address indexes of the clients according to network address information of the clients and adjacent node servers;

obtaining, by any one client, talk information of the players from other clients except the client according to the network address indexes; and

receiving, by the node server, vote information sent by the all players through the clients, and configuring a status of a client corresponding to a player having the most votes as an out status.

It can be seen from the above technical solutions that, in the communication method of the network game, the communication system of the network game and the method for implementing the network game, the identities of the players in the same scenario are transformed into the network address indexes of the clients, so point-to-point (P2P) communication can be implemented between the clients, and it can be avoided that in the conventional communication method of the network game, overfull network resources are occupied because the clients forward messages through the home node servers of the clients, thereby improving communication efficiency and user experiences.

### BRIEF DESCRIPTION OF THE DRAWINGS

FIG. 1 is a schematic diagram illustrating a network topology for implementing a network game according to an embodiment of the present invention.

FIG. 2 is a schematic diagram illustrating a communication system of a network game according to an embodiment of the present invention.

FIG. 3 is a flowchart illustrating a communication method of a network game according to an embodiment of the present invention.

FIG. 4 is a flowchart illustrating a network killing game performed at a node server according to an embodiment of the present invention.

FIG. 5 is a schematic diagram illustrating the structure of a node server according to an embodiment of the present invention.

FIG. 6 is a schematic diagram illustrating the structure of a client according to an embodiment of the present invention.

FIG. 7 is a schematic diagram illustrating a demo interface of a network game performed at a client according to an embodiment of the present invention.

### DETAILED DESCRIPTION OF THE INVENTION

In order to make the object, solutions and merits clearer, the present invention will be illustrated hereinafter in detail with reference to the accompanying drawings and embodiments.

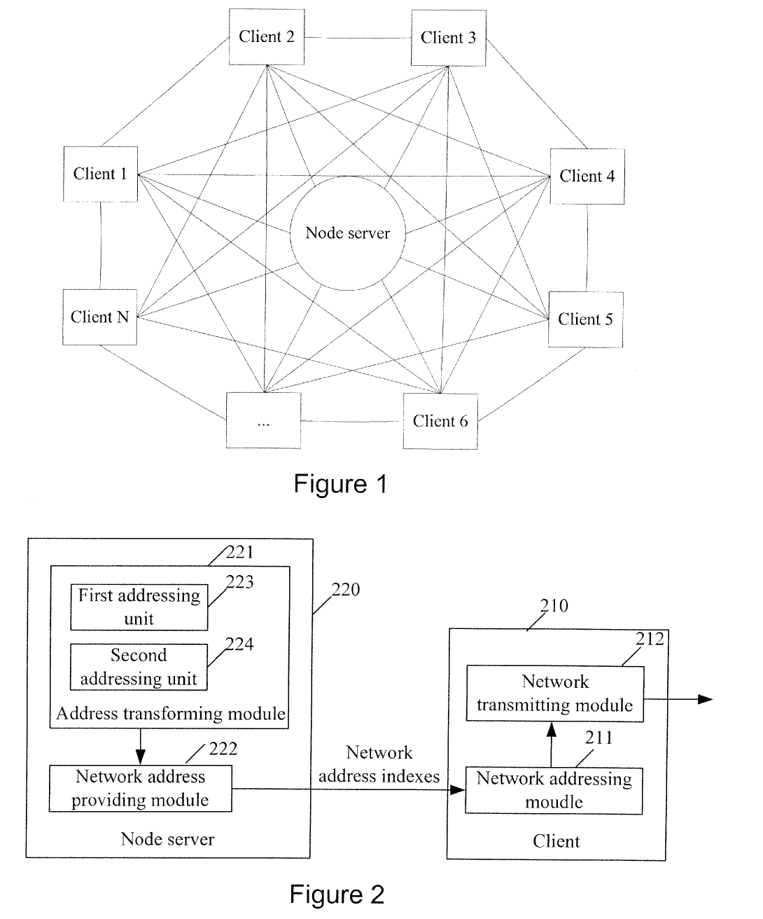

FIG. 1 is a schematic diagram illustrating a network topology for implementing a network game according to an embodiment of the present invention. As shown in FIG. 1, the network includes at least one client logging on a network game by using an independent identity (ID) and a node server providing service support for the at least one client. As can be seen from FIG. 1, P2P communication can be implemented between the clients; at the same time, the node server can perform broadcast. The node server can also provide intelligent route addressing between multiple clients, so as to support global transmission addressing of the P2P communication and global transmission addressing of broadcast in the network game.

In the embodiment of the present invention, the client may be any terminal device logging on the network game by using an independent ID, such as a personal computer (PC), a mobile phone and a personal digital assistant (PDA) etc., or may be instant communication software running on any terminal device, such as a browser and the like.

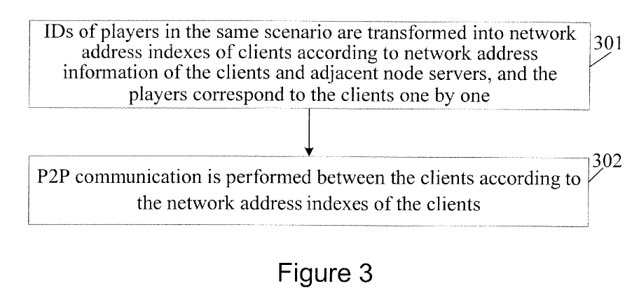

FIG. 2 is a schematic diagram illustrating a communication system of a network game according to an embodiment of the present invention. As shown in FIG. 2, the system includes a client 210 and a node server 220.

The node server 220 transforms IDs of players in the same scenario into network address indexes of clients according to network address information of the clients and adjacent node servers. The network address information of the clients and the adjacent node servers may be configured in advance or automatically generated by a system. For example, the network address information of a client may include an IP address of the client and an ID of a player corresponding to the client.

The client 210 performs P2P communication with other clients except the client 210 according to the network address indexes.

Specifically, the client 210 includes:

a network addressing module 211, adapted to search out, according to the network address indexes of the clients which are transformed from the IDs of the players in the same scenario by the node server 220, a network address index of an opposite client performing the P2P communication with the client; and

a network transmitting module 212, adapted to perform the P2P communication with the opposite client according to the network address index of the opposite client obtained by the network addressing module 211.

The node server 220 includes:

an address transforming module 221, adapted to transforms the IDs of the players in the same scenario into the network address indexes of the clients according to the network address information of the clients and the adjacent node servers which is configured in advance or automatically generated by the system; and

a network address providing module 222, adapted to provide the network address indexes transformed from the IDs of the players by the address transforming module 221 to all connected clients.

The address transforming module 221 includes:

a first addressing unit 223, adapted to, when the scenario corresponds to one node server, take the node server corresponding to the scenario as a home node server of all clients entering the scenario; the home node server provides codes for network address indexes of all clients entering the scenario and transforms the IDs of players into network address indexes according to a relation between the players and the clients.

In the embodiment, one node server fixedly manages a certain number of rooms, and each room corresponds to a game scenario and also corresponds to one fixed home node server. When logging on, each client may log on a nearest node server according to a nearby principle or log on a node server having the best network communication quality. When a certain client selects to enter a room, the node server automatically makes the client re-log on the home node server of the room, i.e. the home node server which corresponds to the scenario corresponding to the room, and the home node server provides codes for the network address indexes of all clients entering the scenario and transforms the IDs of the players into network address indexes according to the relation between the players and the clients. The codes provided for the network address indexes may be numbers of the players in the network game.

The address transforming module 221 further includes a second addressing unit 224. When each client has a configured home node server, the configured home node server provides a code for the network address index of the client and transforms the ID of the player into a network address index according to the relation between the player and the client.

In this embodiment, the node server 220 may fixedly manage a certain number of clients, i.e. the node server 220 is a home node server of the clients. When a certain client logs on, the client logs on a home node server of the client, and the home node server provides a code for the network address index of the client and transforms the ID of the player into a network address index according to the relation between the player and the client.

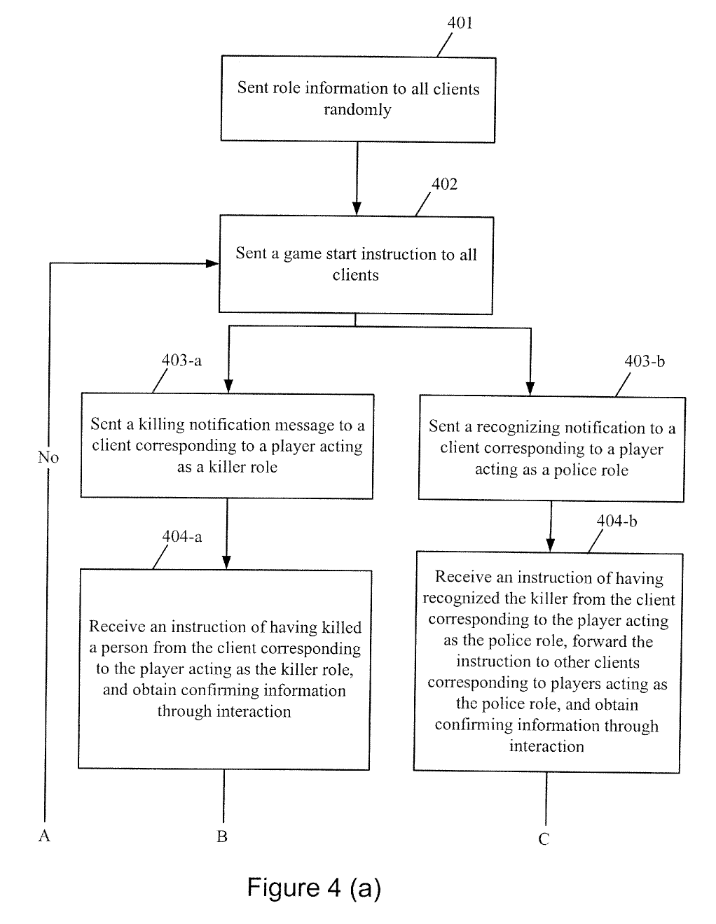

FIG. 3 is a flowchart illustrating a communication method of a network game according to an embodiment of the present invention. As shown in FIG. 3, the communication method of the network game includes the following steps.

Step 301: IDs of players in the same scenario are transformed into network address indexes of clients according to network address information of the clients and adjacent node servers, and the players correspond to the clients one by one.

In this step, there are two methods for transforming the IDs of the players in the same scenario into the network address indexes of the clients.

When the scenario corresponds to one node server, the node server corresponding to the scenario is taken as a home node server of all clients entering the scenario, and the home node server provides codes for network address indexes of all clients entering the scenario and transforms the IDs of the players into network address indexes according to the relation between the players and the clients.

When the client has a configured home node server, the step of transforming the IDs of the players in the same scenario into the network address indexes of the clients includes that the home node server provides a code for the network address index of the client and transforms the ID of the player into a network address index according to the relation between the player and the client.

Step 302: P2P communication is performed between the clients according to the network address indexes of the clients, i.e. information is directly sent between the clients rather than forwarded by the node server. In the embodiment, the information mainly includes audio-video streams generated when the players talk, information on that a player examines video of another player, or text information, actions, expression instructions sent by the player.

In this step, the P2P communication may be implemented by using a P2P protocol.

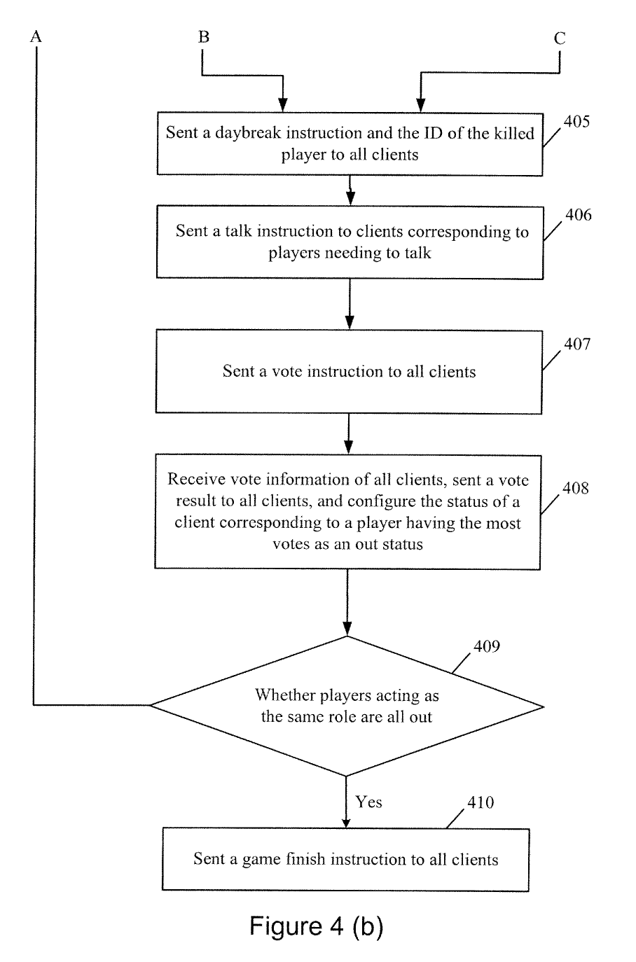

FIG. 4 is a flowchart illustrating a network killing game performed at a node server according to an embodiment of the present invention. As shown in FIG. 4, the network killing game performed at the node server mainly includes the following steps.

Step 401: Role information is sent to all clients randomly.

In the embodiment, a node server sends a game control instruction of “the game starts, please confirm your roles” to all clients after sending the role information to all clients randomly.

Step 402: A game start instruction is sent to all clients.

In the embodiment, the node server sends a game control instruction of “it is dark, please close your eyes”. In the embodiment, the node server may also send stream media information in a broadcast mode.

Step 403-a: A killing notification message is sent to a client corresponding to a player acting as a killer role.

In the embodiment, the node server sends a game control instruction of “killer, please open your eyes and kill a person” to the client corresponding to the player acting as the killer role.

Step 404-a: An instruction of having killed a person is received from the client corresponding to the player acting as the killer role, and is forwarded to other clients corresponding to players acting as the killer role; confirming information is obtained through interaction. For example, the node server receives an ID of a killed player from the client corresponding to the player acting as the killer role, and sends the ID to other clients corresponding to the players acting as the killer role.

In the embodiment, the node server sends a game control instruction of “killer, please close your eyes” to the clients corresponding to the players acting as the killer role. In the embodiment, the confirming information is forwarded between the clients through the node server.

Step 403-b: A recognizing notification is sent to a client corresponding to a player acting as a police role.

In the embodiment, the node server sends a game control instruction of “police, please open your eyes and recognize the killer” to the client corresponding to the player acting as the police role.

Step 404-b: An instruction of having recognized the killer is received from the client corresponding to the player acting as the police role, and is forwarded to other clients corresponding to players acting as the police role, and confirming information is obtained through interaction. For example, the node server receives an ID of the killer sent by the client corresponding to the player acting as the police role, and forwards the ID to other clients corresponding to the players acting as the police role.

In the embodiment, the node server sends a game control instruction of “police, please close your eyes” to the clients corresponding to the players acting as the police role, and stops sending stream media information.

In Steps 403-a, 404-a, 403-b and 404-b of the embodiment, as long as Step 404-a is performed after Step 403-a and Step 404-b is performed after Step 403-b, other steps may be performed in an arbitrary sequence. For example, Step 403-a may be performed firstly, then Steps 403-b and 404-a are performed orderly, and finally Step 404-b is performed; or Step 403-a may be performed firstly, then Steps 404-a and 403-b are performed orderly, and finally Step 404-b is performed. Those skilled in the art should understand that the above examples can not be used to limit the present invention.

Step 405: A daybreak instruction and the ID of the killed player are sent to all clients.

In the embodiment, the node server sends a game control instruction of “daybreak comes, please open your eyes, the player whose ID is number * was killed last night” to all clients.

Step 406: A talk instruction is sent to clients corresponding to players needing to talk.

In the embodiment, the node server sends a game control instruction of “player whose ID is number *, please talk” to the clients corresponding to the players needing to talk. All players may talk through respective clients after receiving the talk instruction. In the embodiment, the node server may transform the IDs of all players into network address indexes of the clients according to the network address information of the clients and adjacent node servers. In this way, any one client can obtain talk information of players from other clients except the client according to the network address indexes.

Step 407 is performed after talk finish messages of all players are received.

Step 407: A vote instruction is sent to all clients.

In the embodiment, the node server sends a game control instruction of “talk is finished, now please vote from the player whose ID is number *, every player can vote for one time, please raise your hand at the first time, and please not follow other's vote” to all clients.

Step 408: Vote information of all clients is received, and a vote result is sent to all clients; the status of a client corresponding to a player indicated by the vote result is configured as an out status.

In the embodiment, the node server selects an ID of a player having the most votes according to the vote result, sends the vote result to all clients, and configures the status of the client corresponding to the player having the most votes as an out status. In addition, a client corresponding to a player acting as a judge role sends a game control instruction of “vote is finished, the player whose ID is number * is determined to be out through the vote of this cycle”.

Step 409: It is determined whether players acting as the same role are all out; if yes, Step 410 is performed; otherwise, Step 402 is performed.

In the embodiment, it is determined whether the players acting as the police role, the players acting as the killer role, or the players acting as the commonalty role are all out.

Step 410: A game finish instruction is sent to all clients.

In the embodiment, the node server sends the game control instructions in the broadcast mode to all clients or to clients of a certain type in the room. Besides, the node server may broadcast node server messages, version update information, room information, free seat information, online user data, broadcast messages sent by the players, advertisements and multimedia stream.

In the embodiment, the node server supports audio-video sharing transmission of multipath P2P technology, i.e. functions of voice and video chat room which are commonly used. Each client can perform P2P communication, i.e. information is directly sent between the clients rather than forwarded by the node server. In the embodiment, the information mainly includes audio-video stream generated when a player talks, information on that a player examines video of another player, or text information, actions, expression instructions sent by the players.

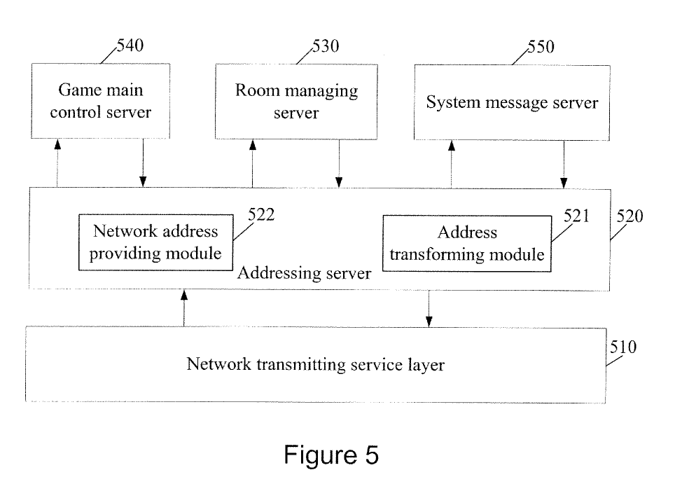

FIG. 5 is a schematic diagram illustrating at the structure of a node server for implementing a network killing game according to an embodiment of the present invention. As shown in FIG. 5, the node server mainly includes the following components.

A network transmitting service layer 510 is adapted to perform network communication with other node servers and all connected clients. In the embodiment, the transmitted contents include: room information, player data, game version information, game logic instructions and node server messages.

An addressing server 520 is adapted to transform IDs of the players into real network addresses according to network address information of all clients and adjacent node servers which is configured in advance or automatically generated by a system. The efficiency of network addressing directly affects the performance of the whole node server.

The embodiment adopts a home room addressing mode, i.e. each node server fixedly manages a certain number of rooms. When logging on, each client may log on a nearest node server according to a nearby principle or may log on a node server having the best network communication quality. Each node server has information about current free seats of all rooms and player data indexes. When a certain client selects to enter a room, the nearest node server automatically makes the client re-log on with the home node server of the room, and informs all node servers to register the re-logging information of the client. Every time the client moves to another room, the client needs to re-log on a node server; if the room to which the client moves is in a local node server, virtual re-logging is formed. Once the game starts, all interaction messages in the room are implemented only between one node server and multiple clients, thereby avoiding the decrease of communication efficiency caused by message forwarding between the nodes. In the home room addressing mode, when players select to enter a certain room, i.e. select to enter a game scenario corresponding to the room, the home node server of the room provides codes for network address indexes of clients corresponding to the players entering the room, e.g. provides numbers for the players in the game, and transforms the IDs of the players into network address indexes according to a relation between the players and the clients.

Of course, the embodiment may also adopt a home seat addressing mode, i.e. one node server fixedly manages a certain number of clients, and each client usually has one basically changeless home node server; only in few cases, e.g. when the home node server is unusable or there is a node server having better network communication quality, the home node server is changed. Each client logs on its own home node server when logging on, and each node server has information about current free seats of all rooms and player indexes. When a certain player selects to enter a room, the home node server of the client corresponding to the player synchronizes the information with all node servers. The home node server provides a unique code for the network address index of the client according to a room number, a table number, or a seat number. When the game starts, all interaction messages in the room are forwarded between the clients according to the unique network address indexes. In this way, communication status between the clients and the node servers can be guaranteed, and the message transmission between the clients may be implemented through a special network, thereby improving communication efficiency.

The above two addressing modes may be flexibly selected according to the number of users logging on the node server, the configuration of the node servers and the network. Therefore, the addressing server 520 includes an address transforming module 521 and a network address providing module 522. The address transforming module 521 transforms IDs of players in the same room into network address indexes of the clients according to network address information of the clients and adjacent node servers which is configured in advance or automatically generated by a system. The network address providing module provides the network address indexes transformed from the IDs of the players by the second addressing module to all connected clients.

The embodiment also includes the following devices.

A room managing server 530 is adapted to manage and synchronize information about free seats of all rooms, player data and player logging and re-logging information. When the game starts, the room managing server automatically closes the room, i.e. does not allow a new player to enter the room, and informs a game main control server to start the game.

The game main control server 540 is adapted to create a game conversation when the game starts. In the embodiment, the game main control server acting as a judge role receives and sends game control instructions according to game rules of a preconfigured version, manages all clients in the room to play the game synchronously.

A system message server 550 is adapted to transmit all broadcast messages of non-game control types.

In the embodiment, the broadcast messages of non-game control types mainly includes: system messages such as advertisements, actions and a player logging and re-logging information, version update information and player broadcast messages.

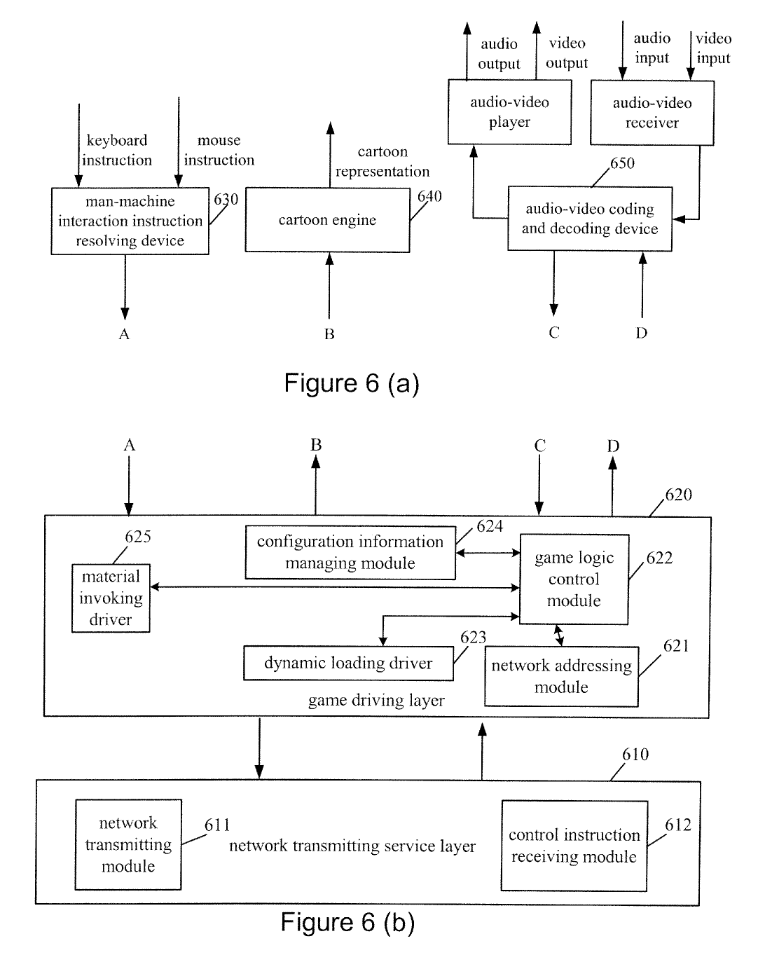

FIG. 6 is a schematic diagram illustrating the structure of a client for implementing a network killing game according to an embodiment of the present invention. As shown in FIG. 6, the structure of the client includes the following components.

A game driving layer 620 is adapted to control a game logic and the scheduling of modules, forward messages, manage player data such as IDs, game levels, successes, playacts and the like, manage game version information and dynamic load, configure addresses of network nodes and addressing algorithms, load and drive cartoon and audio-video materials. The game driving layer 620 includes a network addressing module 621 adapted to search out a network address index of an opposite client performing a P2P communication with the client according to network address indexes of all clients in the same room which are transformed from the IDs by the node server. Besides the network addressing module 621, the game driving layer 620 also includes a game logic controlling module 622 adapted to control the game logic and the scheduling of modules, a configuration information managing module 624 adapted to manage the player data and game configuration information, and a dynamic loading driver 623 adapted to load and drive the cartoon and audio-video materials, and a material invoking driver 625.

A network transmitting service layer 610 is adapted to perform network communication with the node server and other clients in the same room. The transmitted contents include: room information, player data information, game version information, game logic instructions, audio-video information, text information, player expressions and action instructions, and node server messages. The network transmitting service layer 610 includes a network transmitting module 611 and a control instruction receiving module 612. The network transmitting module 611 can perform the P2P communication with the opposite client according to the network address index of the opposite client obtained by the network addressing module 621 in the game driving layer 620. The control instruction receiving module 612 can receive game control instructions generated by the node server. The control instruction receiving module 612 may send the received game control instructions to the game driving layer 620; the game logic control module 622 in the game driving layer 620 notifies other modules in the game driving layer 620 after receiving the game control instructions, and other modules perform related processing according to the game control instructions.

An audio-video coding and decoding device 650 is adapted to code and decode audio-video signals to implement the transformation between the transmitted signals and signals played by the device, so as to establish a communication connection of audio and/or video stream according to the game control instructions and provide the audio and/or video stream to the virtual characters.

The client may also include following components.

A man-machine interaction instruction resolving device 630 is adapted to obtain the game control instructions from input devices of a PC, e.g. a keyboard, a mouse and the like, transform the game control instructions into internal messages of the node server, and send the internal messages to a logic control unit.

In order to simplify user operations, in the embodiment of the present invention, multiple functions may be defined for a multi-function key according to the game flow so as to implement a one-key operation. For example, in the night, a shortcut key may be used for recognizing a killer by the client corresponding to the player acting as the police role, and may also be used for killing a person by the client corresponding to the player acting as the killer role. For another example, in the daytime, when the players are talking in turn, the shortcut key may be used for talking or stopping talk by the clients; when the players are voting, the shortcut key may be used for voting by the clients.

A cartoon engine 640 is adapted to receive control instructions sent by the game driving layer, invoke loaded cartoon materials to implement corresponding cartoon representation. The cartoon contents mainly include: room scenario representation, multi-angle view transformation, player virtual characters, player playact representations, player virtual expressions, action representations and game flow representations.

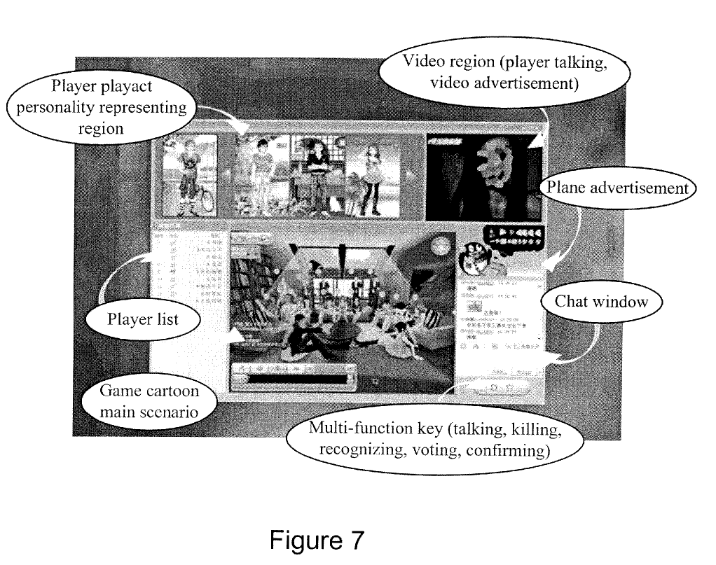

FIG. 7 is a schematic diagram illustrating a demo interface of a game performed in a client according to an embodiment of the present invention. As shown in FIG. 7, a scenario of a network killing game is represented verily by using audio and video multimedia technologies. In addition, the game is more interesting by using the virtual characters and scenario implemented by the cartoon technologies.

The foregoing are only preferred embodiments of the present invention and are not for use in limiting the protection scope of the present invention. Any modification, equivalent replacement and improvement made within the scope of the present invention should be covered under the protection scope of the present invention.

1. A communication method of a network game, comprising:
transforming, by a node server, identities (IDs) of players in a same scenario into network address indexes of clients according to network address information of the clients and adjacent node servers, the players corresponding to the clients one by one; and
performing, by a client, point-to-point (P2P) communication with other clients except the client according to the network address indexes.

2. The method of claim 1, wherein the scenario corresponds to one node server, and transforming IDs of players in a same scenario into network address indexes of clients comprises:
taking the node server corresponding to the scenario as a home node server of all clients entering the scenario; providing, by the home node server, codes for network address indexes of the all clients entering the scenario, transforming the IDs of the players into the network address indexes according to a relation between the players and the clients.

3. The method of claim 1, wherein each client has a configured home node server, and transforming IDs of players in a same scenario into network address indexes of clients comprises:
providing, by the home node server, a code for an network address index of the client, transforming an ID of a player corresponding to the client into a network address index according to a relation between the player and the client.

4. The method of claim 1, where the scenario is a virtual scenario represented in a cartoon mode.

5. The method of claim 1, further comprising:
performing, by the clients, forwarding communication between the clients through respective home node servers.

6. The method of claim 1, wherein performing, by a client, P2P communication with other clients except the client according to the network address indexes comprises:
searching out, by the client, a network address index of an opposite client performing the P2P communication with the client according to the network address indexes of the clients in the same scenario transformed from the IDs of the players by the node server; performing the P2P communication with the opposite client according to the network address index of the opposite client.

7. The method of claim 6, further comprising:
receiving, by the client, a game control instruction generated by the node server, establishing an audio and/or video connection according to the game control instruction;
wherein performing the P2P communication with the opposite client according to the network address index of the opposite client comprises:
performing, by the client, the P2P communication of audio and/or video with the opposite client according to the network address index of the opposite client.

8. A communication system of a network game, comprising:
a node server, adapted to transform identities (IDs) of players in a same scenario into network address indexes of clients according to network address information of the clients and adjacent node servers, and the players corresponding to the clients one by one; and
a client, adapted to perform point-to-point (P2P) communication with other clients except the client according to the network address indexes.

9. The system of claim 8, wherein the client comprises:
a network addressing module, adapted to search out a network address index of an opposite client performing the P2P communication with the client according to the network address indexes of the clients in the same scenario transformed from the IDs of the players by the node server; and
a network transmitting module, adapted to perform the P2P communication with the opposite client according to the network address index of the opposite client obtained by the network addressing module.

10. The system of claim 8, wherein the node server comprises:
an address transforming module, adapted to transform the IDs of the players in the same scenario into the network address indexes of the clients according to the network address information of the clients and the adjacent node servers which is configured in advance or automatically generated by a system; and
a network address providing module, adapted to provide the network address indexes transformed from the IDs of the by the address transforming module to all connected clients.

11. The system of claim 10, wherein the address transforming module comprises:
a first addressing unit, adapted to, when the scenario corresponds to one node server, take the node server corresponding to the scenario as a home node server of all clients entering the scenario; the home node server provides codes for network address indexes of the all clients entering the scenario, transforming the IDs of the players into the network address indexes according to a relation between the players and the clients; and
a second addressing unit, adapted to, when each client has a configured home node server, the configured home node server provides a code for a network address index of the client, transforming an ID of a player corresponding to the client into a network address index according to a relation between the player and the client.

12. The system of claim 9, wherein the client further comprises:
a control instruction receiving module, adapted to receive a game control instruction generated by the node server; and
a audio/video providing module, adapted to establish a connection of audio and/or video stream according to the game control instruction obtained by the control instruction receiving module;
the node server further comprises:
a game control module, adapted to generate the game control instruction; and
the network transmitting module, adapted to perform the P2P communication of audio and/or video with the opposite client according to the network address index of the opposite client obtained by the network addressing module.

13. A method for implementing a network killing game, comprising:
sending, by a node server, a killing notification message to a client corresponding to a player acting as a killer role, and receiving an identity (ID) of a killed player sent by the client corresponding to the player acting as the killer role;
sending, by the node server, the identity of the killed player to clients corresponding to all players, the players corresponding to the clients one by one;
talking, by the players, by using respective clients;
the method further comprising:
transforming, by the node server, IDs of the all players into network address indexes of the clients according to network address information of the clients and adjacent node servers;
obtaining, by any one client, talk information of the players from other clients except the client according to the network address indexes; and
receiving, by the node server, vote information sent by the all players through the clients, and configuring a status of a client corresponding to a player having the most votes as an out status.

14. The method of claim 13, further comprising:
randomly sending, by the node server, role information to the clients corresponding to the all players before sending the killing notification message to the client corresponding to the player acting as the killer role.

15. The method of claim 13, further comprising:
sending, by the node server, an instruction of recognizing a killer to a client corresponding to a player acting as a police role before sending the ID of the killed player to the clients corresponding to the all players, and receiving an ID of the killer sent by the client corresponding to the player acting as the police role.

16. The method of claim 13, further comprising:
determining, by the node server, whether statuses of clients corresponding to players acting as the same role are all configured as an out status after configuring a client corresponding to a player having the most votes as an out status; if the statuses of the clients corresponding to the players acting as the same role are all configured as the out status, sending a game finish instruction to the clients corresponding to the all players; otherwise, sending the killing notification message to the client corresponding to the player acting as the killer role and continuing the game.

17. The method of claim 14, further comprising:
determining, by the node server, whether statuses of clients corresponding to players acting as the same role are all configured as an out status after configuring a client corresponding to a player having the most votes as an out status; if the statuses of the clients corresponding to the players acting as the same role are all configured as the out status, sending a game finish instruction to the clients corresponding to the all players; otherwise, sending the killing notification message to the client corresponding to the player acting as the killer role and continuing the game.

18. The method of claim 15, further comprising:
determining, by the node server, whether statuses of clients corresponding to players acting as the same role are all configured as an out status after configuring a client corresponding to a player having the most votes as an out status; if the statuses of the clients corresponding to the players acting as the same role are all configured as the out status, sending a game finish instruction to the clients corresponding to the all players; otherwise, sending the killing notification message to the client corresponding to the player acting as the killer role and continuing the game.
